(19) United States
(12) Patent Application Publication
(10) Pub. No.: US 2005/0090923 A1
(43) Pub. Date: Apr. 28, 2005

(54) Method for monitoring a batch system

(76) Inventor: Norman Rieker, Glen Allen, VA (US)

Correspondence Address: GERO G. McCLELLAN;MOSER, PATTERSON & SHERIDAN, L.L.P, Suite 1500, 3040 Post Oak Blvd., Houston, TX, 77056, US

(21) Appl. No.: 10/933,566

(22) Filed: Sep. 3, 2004

(30) Foreign Application Priority Data
Sep. 3, 2003 (DE) 103 40 511.9-33

(51) Int. Cl. G06F 19/00

(52) U.S. Cl. 700/109; 700/121

(57) ABSTRACT

System and method for processing semiconductor wafers are provided. One embodiment provides a method for monitoring a batch system. For the purpose of monitoring batch systems, in accordance with a defined rotation principle, during successive passes of the batch system, a predefined number of test wafers is moved to changing positions in a boat, so that after a complete rotation cycle, in which test wafers and/or product wafers are inspected after specific passes, a statement about the condition of the batch system and the quality of the processing process is achieved.

### CROSS-REFERENCE TO RELATED APPLICATIONS

This application claims foreign priority benefits under 35 U.S.C. §119 to co-pending German patent application number DE 103 40 511.9-33, filed Sep. 3, 2003. This related patent application is herein incorporated by reference in its entirety.

### BACKGROUND OF THE INVENTION

1. Field of the Invention

The present invention relates to a system for monitoring a batch system.

2. Description of the Related Art

During the processing of semiconductor wafers for the production of semiconductor components, use is preferably made of batch systems in which a plurality of semiconductor wafers can be processed simultaneously. The load, i.e., all the semiconductor wafers loaded into the batch system and to be processed, is in this case accommodated in a boat, i.e., an apparatus for holding the semiconductor wafers vertically or horizontally.

The most important batch systems which are used in semiconductor technology include systems for chemical gas phase deposition, also called the CVD (chemical vapor deposition) process. With the aid of CVD systems, primarily thin dielectric layers can be produced on semiconductor wafers. The supporting devices used for a semiconductor wafer load in CVD systems are normally boats in the form of a frame having a plurality of rods arranged in parallel, which are in each case provided with slots arranged at right angles to the rods, into which the semiconductor wafers can be inserted. In the boat, the semiconductor wafers can be aligned horizontally or vertically during the coating process in accordance with the stipulations of the CVD system.

To achieve reliable system monitoring and to monitor a plurality of boat sections at the same time, as a rule a plurality of semiconductor wafers from a load processed in the batch system are selected for test inspections. Such a monitoring method, in which in general both special test wafers and also production wafers are inspected, certainly ensures comprehensive assessment of the state of the system and the quality of the production process. However, the necessary comprehensive wafer inspections lead to a considerable financial, logistic and fabrication-based expenditure.

### SUMMARY OF THE INVENTION

It is an object of the invention to provide a method which permits reliable monitoring of batch systems with reduced financial, logistic and fabrication-based expenditure.

According to embodiments of the invention, in accordance with a defined rotation principle, during successive passes (also referred to herein as “runs”) of the batch system, a predefined number of test wafers are moved to changing positions in the boat. After a complete rotation cycle, in which test wafers and/or product wafers are inspected after specific passes, a comprehensive statement about the condition of the batch system and the quality of the production process is possible. Advantages of the method according to embodiments of the invention are multiple savings in time and materials and a reduction in the operative effort in the fabrication, with the simultaneous possibility of reliable assessment of the batch system. Thus, as compared with conventional methods of monitoring batch systems, according to embodiments of the invention, up to five times fewer test wafers per run and one to five times less effort on measurement by the fabrication personnel are necessary.

According to one embodiment of the invention, during specific passes of the batch system, it is possible not to make any measurement and/or to vary the type of measurement, i.e., measurement of test and/or product wafer.

According to a further embodiment of the invention, it is determined whether the batch system to be assessed achieves a defined minimum fabrication volume, in order to ensure that sufficient data for assessment is obtained.

Furthermore, according to embodiments of the invention, the rotation of the test wafers, e.g., within the load in the boat of the batch system, is achieved by means of a changed load pattern while the arrangement of the production wafers are not changed, which produces no detrimental effect on the fabrication process.

According to an embodiment of the invention, an automatic change in the load pattern is carried out by means of an algorithm, which can be implemented externally or locally on the batch system. In this case, the load pattern itself or a component controlling the loading of the semiconductor wafers into the boat is changed.

Furthermore, according to a further embodiment of the invention, a user interface is provided in order to be able to define the parameters of the test wafer rotation. Furthermore, by means of a status display, information can be given about the current location status and, under certain circumstances, the operating personnel can be requested to load additional test wafers during subsequent runs of the batch system. In addition, a log mechanism can be provided in order to be able to understand changes in the parameters of the test wafer rotation and to diagnose possible errors.

### BRIEF DESCRIPTION OF THE DRAWINGS

The invention will be explained in more detail in the following text by using the figures, in which:

FIG. 1 shows a batch system using the example of an LPCVD system, on which a method according to one embodiment of the invention for monitoring the batch system may be carried out; and

FIG. 2 shows an exemplary embodiment of a method according to one embodiment of the invention for monitoring a batch system, in which FIG. 2A shows an architecture of a program for carrying out the method according to one embodiment of the invention, and FIG. 2B shows a program for defining parameters of the method according to one embodiment of the invention.

### DETAILED DESCRIPTION OF THE PREFERRED EMBODIMENT

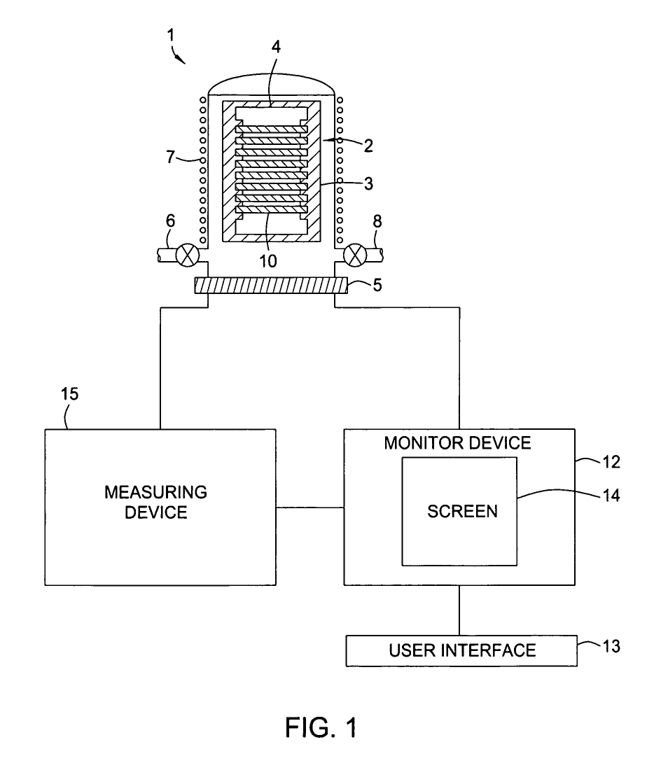

FIG. 1 shows a schematic sectional illustration through an LPCVD system for deposition of thin layers on semiconductor wafers. The method according to one embodiment of the invention for monitoring a batch system will be explained by way of example using such an LPCVD system. The method according to one embodiment of the invention may, however, be used in all other known batch systems in which a plurality of semiconductor wafers are processed simultaneously.

The LPCVD system shown in FIG. 1 comprises a process chamber 1, in which a carrier device 2, also designated a boat (used interchangeably herein), is arranged horizontally and is loaded with the semiconductor wafers 10 to be processed. The entirety of all the semiconductor wafers 10 loaded into the boat and to be processed simultaneously in the LPCVD system is called a load. The boat 2 has a frame comprising a plurality of rods 3 which are oriented in parallel and connected to one another by transverse struts 4. On the sides facing the semiconductor wafers 10, the rods 3 are in each case provided with slots arranged at right angles to the rods 3, into which the semiconductor wafers 10 can be inserted, so that the rods 3 enclose the semiconductor wafers 10 in the manner of a semicircle. In the sectional illustration chosen in FIG. 1, only two rods 3 are depicted.

For the coating process, the process chamber 1 of the LPCVD system is loaded with the boat 2 carrying the batch via an airlock 5. For the coating procedure itself, gases are then led into the process chamber 1 via a gas inlet 6. To generate the temperatures required for the coating process, the process chamber 1 has heating elements 7 on the side walls, in order to heat up the interior of the process chamber and therefore the boat with the load. On the surfaces of the semiconductor wafers 10 heated up in this way, a reaction occurs with the process gases introduced such that reaction products are deposited on the semiconductor wafers. The residual gases produced are then led out of the process chamber 1 via a gas outlet 8. The gas outlet 8 is also connected to a vacuum pump, not illustrated, to produce the low pressure required for the LPCVD coating process.

To control and monitor the coating procedure in the process chamber 1, a monitor device 12 is used, which is connected to the process chamber 1 to predefine the parameters of the coating procedure and to control the coating process itself. The monitor device 12 also has a user interface 13 for the operating personnel of the LPCVD system and also a screen 14 for displaying information about the coating procedure and about the LPCVD system.

Furthermore, with the aid of a connected measuring device 15, which is in turn connected to the process chamber 1, the monitor device 12 carries out system monitoring. For this purpose, following individual coating passes in various sections of the boat 2 semiconductor wafers may be removed from the process load and inspected in the measuring device 15. To inspect the quality of the coating process for the purpose of system monitoring, different measuring techniques may be utilized. For example, the measurement techniques may include an optical or mechanical layer thickness measurement or a visual inspection with the aid of a microscope. To ensure comprehensive assessment of the state of the system and the quality of the deposition process, as a rule, specific testing wafers are additionally contained in the processed load so that inspections which typically damage the semiconductor wafers may be carried out on the testing wafers. At the same time, product wafers for system monitoring may also be inspected with the test wafers.

To be able to carry out reliable monitoring of the LPCVD system with the lowest possible operative effort and financial expenditure, according to one embodiment of the invention, within the scope of a fabrication process, a rotation cycle with a predefined number of runs of the LPCVD system is defined by the monitor device 12, wherein a predefined number of test wafers are arranged at changing positions in the boat during various runs. The monitor device 12 then controls the batch system in such a way that a complete rotation cycle of runs, in which in each case (i.e., after each cycle) a load of semiconductor wafers is processed, is carried out. After each run, the test wafers arranged at changing positions in the boat and/or the production wafer taken from different positions in the boat are inspected. From the measured results determined over the entire rotation cycle by using the test and production wafers inspected, an assessment of the LPCVD system and the coating procedure carried out is then performed. The number of test wafers used per run may be defined on the basis of the respective batch process or the size of the load and the extent of the boat. The number and position of the tested product wafers from the respectively processed batch may be defined on the same basis.

Furthermore, the method according to one embodiment of the invention for monitoring the LPCVD system can be designed such that, within a rotation cycle, during specific runs of the batch systems, no measurements are made and/or the type of the measurements, i.e., test and/or production wafers, is changed. In this way, the expenditure on measurement can be reduced, and at the same time, the number of test wafers required can be reduced. As compared with the conventional systems monitoring methods in batch systems, in particular LPCVD systems, the number of test wafers and therefore the expenditure on measurement can be reduced to a fifth in this way.

The monitor device 12 is, furthermore, designed such that a minimum number of runs in a rotation cycle are carried out for system monitoring to ensure that sufficient data for system assessment is obtained. If this is not possible, this may be indicated to the operating personnel on the screen 14 of the monitor device 12. During the rotation of the test wafers in a rotation cycle for system assessment, defined by the monitor device 12, the arrangement of the test wafers in the boat is varied from run to run in such a way that the arrangement of the product wafers in the load is not changed, in order not to have a detrimental effect overall on the fabrication process. The change in the load pattern in this case may be carried out with the aid of an algorithm which is implemented in the monitor device 12. To change the arrangement of the test wafers in the load pattern, the load pattern itself or a component controlling the loading of the semiconductor wafers into the boat can be changed appropriately.

Furthermore, the operating personnel may define the parameters of the test wafer rotation or of the rotation cycle, as appropriate, via the user interface 13. At the same time, the operating personnel may be informed about the current rotation status by means of a status display on the screen 14 and, if appropriate, be requested to take actions, for example, to load additional test wafers for subsequent runs of the batch system. In addition, the monitor device 12 may contain a log mechanism to record changes in the parameters of the test wafer rotation, to diagnose and then, if appropriate, to output error messages on the screen 14.

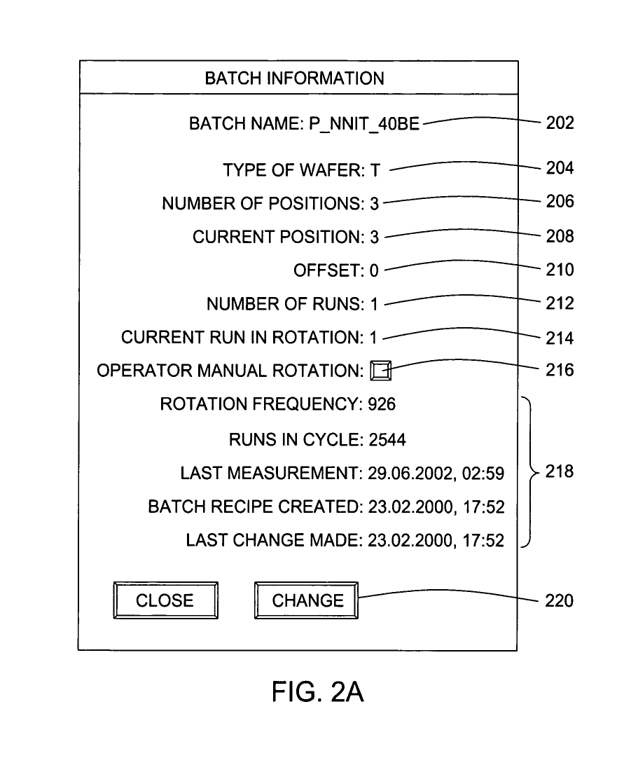

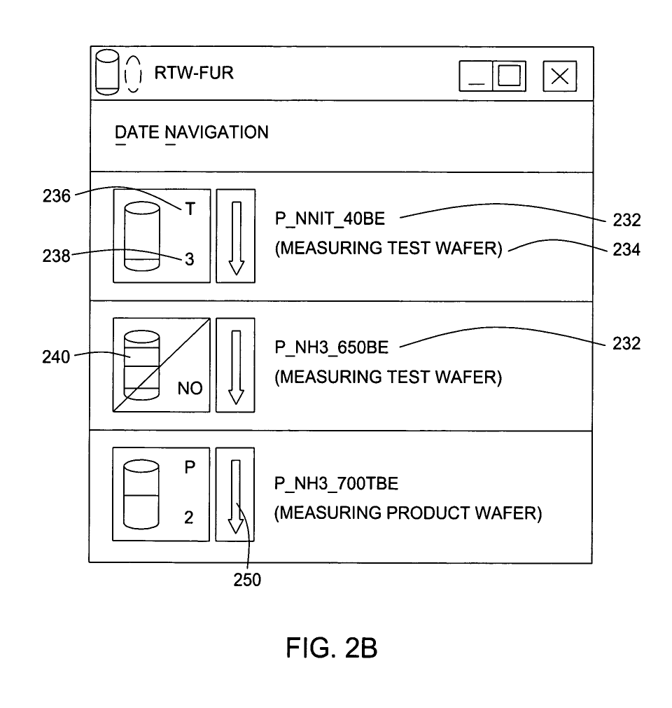

One embodiment of the method for monitoring a batch system, as may be implemented as an additional software component in the monitor device 12, for example, is illustrated in FIG. 2. The graphical user interface of the program, which is displayed on the screen 14, may be implemented using window/browser technology, as illustrated in FIGS. 2A and 2B. The measurement method for system monitoring suitable for the respective batch system may be implemented by means of providing various method sequences, also referred to herein as the batch recipe, in a database, which can be selected by the operating personnel or selected automatically by using the parameters of the process to be carried out by the batch system.

FIG. 2A shows one embodiment of a display setting for a bench recipe for monitoring a batch system such as an LPCVD system. The data set for defining the monitoring method contains the following information, which can be displayed on the screen 14 of the monitor device 12. To identify and select the batch sequence, a name 202, e.g., P_NNIT_40BE, is assigned in the batch recipe. Furthermore, the type of wafer 204 to be measured in the respective run, i.e., product and/or test wafer, is defined with “T” standing for test wafer and “P” standing for production wafer. As a further parameter, the number of positions 206 in the boat, e.g., “3”, to which the test wafers are to be rotated during a rotation cycle is specified. Additionally specified, based on the respective run in the rotation cycle, is the current position 208 of the test wafer in the boat, e.g., “3”. Furthermore, an offset 210, e.g., “0”, of all the positions in the boat may be defined to shift the positions of the wafers in the boat upward by the appropriate offset and in this way to permit additional rotation positions in the boat. Further specified is the number of runs 212 after which a measurement is to be made, e.g., “1” or after each run. Furthermore, the position of the current run 214 in the rotation cycle, e.g., “1”, is defined. In addition, by displaying a check mark or a space, it is determined whether the operating personnel may carry out a manual rotation 216, for example, to force the next measurement to be carried out at a specific position in the boat.

In addition, general information 218 relating to the batch recipe may be displayed, including specifically how often a rotation is made, e.g., 926 times, how many runs the cycle contains, e.g., 2544, when the measurement cycle was carried out for the last time, e.g., on 06.29.2002 at 02:59, when the batch recipe was created, e.g., on 23.06.2002 at 17:52 and when the last change was made, e.g., on 06.23.2002 at 17:52. Also provided is a change mode for the rotational setting of the batch recipe, which is indicated by the Change button 220. If necessary, the batch recipe can then be changed by the operating personnel with the aid of the user interface 13. However, there is also the possibility of intervening in the rotational setting of the batch recipe by means of a remote interface (not shown) and of changing said recipe or of downloading a new data set.

FIG. 2B shows the database with the various batch recipes, as they may be displayed on the screen 14 of the monitor device 12. The status display of the database may be presented in color to permit rapid recognition by the operating personnel. The individual batch recipes may be arranged one under another in blocks. Three batch recipes are shown in FIG. 2B. The display of the batch recipe for selection by the operating personnel may be provided in the following manner. In the topmost field, the name of the batch recipe 232 and the type of the measurement 234, i.e., measurement of product and/or test wafer, is indicated. Furthermore, the type of measurement may again be displayed as a graphic symbol 236, e.g., with T and/or P. Furthermore, the current position 238 of the test wafer in the boat is also indicated. A color signal indicator may be utilized to represent a change in position of the test wafers and also the next action to be performed. With the aid of the color of a cylinder, a signal (i.e., color signal indicator 240) is given as to whether no measurement is to be carried out in the next run (for example, red areas), whether a measurement is to be made in the next run (for example, green areas) or whether test means are to be loaded in the next run (for example, colorless cylinder). Furthermore, an arrow 250 may be utilized to indicate symbolically whether manual rotation by the operating personnel of the wafers to be measured is permissible. From three data sets shown in FIG. 2B, with the aid of the user interface, the operating personnel can select the best recipe suitable for the process to be run on the batch system. However, this selection may also be carried out automatically.

In addition to the database architecture for carrying out the method for monitoring batch systems shown and explained in FIG. 2, differently configured databases or graphic display methods and control possibilities may be provided, which can be implemented externally and/or in the batch system itself.

While the foregoing is directed to embodiments of the present invention, other and further embodiments of the invention may be devised without departing from the basic scope thereof, and the scope thereof is determined by the claims that follow.

1. A method for monitoring a batch system for processing a plurality of semiconductor wafers arranged in a boat, comprising:
defining a rotation cycle comprising a predefined number of runs through the batch system, each run having a load pattern of product wafers and test wafers, the load pattern defined by test wafer positions and product wafer positions in a processing chamber of the batch system;
for each of the predefined number of runs,
removing processed wafers from the processing chamber; and
introducing a next set of product wafers and test wafers having a different load pattern from the removed processed wafers; and
selectively inspecting at least one of the processed test wafers and the product wafers after selected runs.

2. The method of claim 1, further comprising:
completing the runs of the rotation cycle; and
assessing a performance of the batch system.

3. The method of claim 1, wherein, after each n^{th} run (n≧1), performing one of measuring the at least one of the test wafer and production wafer selected for inspection and changing a type of measurement between a test wafer and a product wafer.

4. The method of claim 1, further comprising:
defining a minimum number of runs to generate sufficient measured data for assessing a performance of the batch system.

5. The method of claim 1, wherein the change in the position of the test wafers within the boat of the batch system is carried out in such a way that the arrangement of the product wafers is not changed.

6. The method of claim 1, wherein the position of the test wafers within the boat is changed according to an algorithm.

7. The method of claim 1, wherein a user interface is provided to define one or more parameters of the rotation cycle.

8. The method of claim 1, displaying a status of the rotation cycle being carried out on the batch system.

9. The method of claim 1, further comprising:
recording changes in one or more parameters of the rotation cycle; and
analyzing the changes to determine whether an error has occurred.

10. A batch system for processing a plurality of semiconductor wafers, comprising:
a processing chamber for processing the semiconductors wafers arranged in a boat;
a measuring device for measuring a selected wafer, the selected wafer being one of a product wafer and a test wafer;
a monitoring device configured to perform a method for monitoring the batch processing system, the method comprising:
defining a rotation cycle comprising a predefined number of runs through the batch system, each run having a load pattern of product wafers and test wafers, the load pattern defined by test wafer positions and product wafer positions in a processing chamber of the batch system;
for each of the predefined number of runs,
removing processed wafers from the processing chamber; and
introducing a next set of product wafers and test wafers having a different load pattern from the removed processed wafers; and
selectively inspecting at least one of the processed test wafers and the product wafers after selected runs.

11. The system of claim 10, wherein the method further comprises:
completing the rotation cycle; and
assessing a performance of the batch system.

12. The system of claim 10, wherein, after each n^{th} run (n≧1), performing one of measuring the at least one of the test wafer and production wafer selected for inspection and changing a type of measurement between a test wafer and a product wafer.

13. The system of claim 10, further comprising:
a user interface for defining one or more parameters of the rotation cycle.

14. The system of claim 10, further comprising:
a display for displaying a status of the rotation cycle being carried out on the batch system.

15. The system of claim 10, further comprising:
a log mechanism for recording changes in one or more parameters of the rotation cycle and analyzing the changes to determine whether an error has occurred.

16. A method for processing semiconductor wafers, comprising:
for each run of wafers processed through a batch system, selectively arranging a plurality of product wafers and one or more test wafers in a load pattern in a boat, wherein the one or more test wafers are arranged in a different position than the test wafer positions from a previous run or a subsequent run;
processing the wafers in a batch processing chamber; and
selectively inspecting at least one of the test wafers and the product wafers.

17. The method of claim 16, further comprising:
defining a rotation cycle comprising a predefined number of runs through the batch processing system;
completing the rotation cycle; and
assessing a performance of the batch system.

18. The method of claim 17, wherein, after each n^{th} run (n≧1), performing one of measuring the at least one of the test wafer and production wafer selected for inspection and changing a type of measurement between a test wafer and a product wafer.

19. The method of claim 16, wherein the load pattern and the test wafer positions are defined utilizing an algorithm.

20. The method of claim 19, further comprising:
providing a user interface for inputting changes to one or more parameters of the load pattern and the test wafer positions.
